(19) United States
(12) Patent Application Publication
(10) Pub. No.: US 2024/0400401 A1
(43) Pub. Date: Dec. 5, 2024

(54) USE OF CATIONS SELECTED FROM 1,2,3,5-TETRAMETHYL-BENZIMIDAZOLIUM, 1,2,3,4,5-PENTAMETHYLBENZIMIDAZOLIUM, AND 1,2,3,4,6-PENTAMETHYLBENZIMIDAZOLIUM AS STRUCTURE DIRECTING AGENTS FOR THE PREPARATION OF MOLECULAR SIEVES AND MOLECULAR SIEVES OBTAINED USING THE SAME

(71) Applicant: EXXONMOBIL TECHNOLOGY AND ENGINEERING COMPANY, Spring, TX (US)

(72) Inventors: Trong D. PHAM, Flemington, NJ (US); Allen W. BURTON, Stewartsville, NJ (US); Eugene A. TEREFENKO, Center Valley, PA (US)

(21) Appl. No.: 18/798,220

(22) Filed: Aug. 8, 2024

Related U.S. Application Data
(63) Continuation of application No. PCT/US2023/061859, filed on Feb. 2, 2023.
(60) Provisional application No. 63/308,793, filed on Feb. 10, 2022.

(51) Int. Cl. C01B 39/48

(52) U.S. Cl. CPC C01B 39/48; C01P 2002/74; C01P 2004/03

(57) ABSTRACT

The present disclosure relates to the use of at least one cation selected from 1,2,3,5-tetramethylbenzimidazolium cation, 1,2,3,4,5-pentamethylbenzimidazolium cation, and 1,2,3,4,6-pentamethylbenzimidazolium cation as a structure directing agent for the preparation of molecular sieves. This disclosure also relates to a method of making molecular sieves using said structure directing agents, and to molecular sieves comprising said structure directing agents.

### CROSS REFERENCE TO RELATED APPLICATIONS

This application is a Continuation of PCT/US2023/061859, filed Feb. 2, 2023, and titled “Use Of Cations Selected From 1,2,3,5-Tetramethylbenzimidazolium, 1,2,3,4,5-Pentamethylbenzimidazolium, And 1,2,3,4,6-Pentamethylbenzimidazolium As Structure Directing Agents For The Preparation Of Molecular Sieves And Molecular Sieves Obtained Using The Same”, which claims the benefit of priority to U.S. Provisional Patent Application No. 63/308,793 filed Feb. 10, 2022, and titled “Use of Cations Selected from 1,2,3,5-Tetramethylbenzimidazolium, 1,2,3,4,5-Pentamethylbenzimidazolium, and 1,2,3,4,6-Pentamethylbenzimidazolium as Structure Directing Agents for the Preparation of Molecular Sieves and Molecular Sieves Obtained Using the Same”, both of which are incorporated herein by reference in their entirety.

### TECHNICAL FIELD

The present disclosure relates to the use of at least one cation selected from 1,2,3,5-tetramethylbenzimidazolium cation, 1,2,3,4,5-pentamethylbenzimidazolium cation, and 1,2,3,4,6-pentamethylbenzimidazolium cation as a structure directing agent for the preparation of molecular sieves. This disclosure also relates to a method of making molecular sieves using said structure directing agents, and to molecular sieves comprising said structure directing agents.

### BACKGROUND OF THE INVENTION

Molecular sieve materials, both natural and synthetic, may be used as adsorbents and have catalytic properties for hydrocarbon conversion reactions. Certain molecular sieves, such as zeolites, AlPOs, and mesoporous materials, are ordered, porous crystalline materials having a definite crystalline structure as determined by X-ray diffraction (XRD). Certain molecular sieves are ordered and produce specific identifiable XRD patterns. Within certain molecular sieve materials there may be a large number of cavities, which may be interconnected by a number of channels or pores. These cavities and pores are uniform in size within a specific molecular sieve material. Because the dimensions of these pores are such as to accept for adsorption molecules of certain dimensions while rejecting those of larger dimensions, these materials have come to be known as “molecular sieves” and are utilized in a variety of industrial processes, e.g. cracking, hydrocracking, disproportionation, alkylation, oligomerization, and isomerization.

Molecular sieves that find application in catalysis and adsorption include any of the naturally occurring or synthetic crystalline molecular sieves. Examples of these molecular sieves include extra-large pore zeolites, large pore zeolites, medium pore size zeolites, and small pore zeolites. These zeolites and their isotypes are classified by the Structure Commission of the International Zeolite Association according to the rules of the IUPAC Commission on Zeolite Nomenclature. According to this classification, framework type zeolites and other crystalline microporous molecular sieves, for which a structure has been established, are assigned a three letter code and are described in the Ch. Baerlocher, L. B. McCusker, and D. H. Olson, eds. “Atlas of Zeolite Framework Types”, Elsevier, Sixth Edition, 2007, which is hereby incorporated by reference. These zeolites and their isotypes are also described in http://America.iza-structure.org/IZA-SC/ftc_table.php.

The idealized inorganic framework structure of zeolites is a framework of silicate in which all tetrahedral atoms are connected by oxygen atoms with the four next-nearest tetrahedral atoms. The term “silicate”, as used herein, refers to a substance containing at least silicon and oxygen atoms that are alternately bonded to each other (i.e., —O—Si—O—Si—), and optionally including other atoms within the inorganic framework structure, including atoms such as boron, aluminum, or other metals (e.g., transition metals, such as titanium, vanadium, or zinc). Atoms other than silicon and oxygen in the framework silicate occupy a portion of the lattice sites otherwise occupied by silicon atoms in an ‘all-silica’ framework silicate. Thus, the term “framework silicate” as used herein refers to an atomic lattice comprising any of a silicate, borosilicate, gallosilicate, ferrisilicate, aluminosilicate, titanosilicate, zincosilicate, vanadosilicate, or the like.

The structure of the framework silicate within a given zeolite determines the size of the pores or channels that are present therein. The pore or channel size may determine the types of processes for which a given zeolite is applicable. Currently, greater than 200 unique zeolite framework silicate structures are known and recognized by the Structure Commission of the International Zeolite Association, thereby defining a range of pore geometries and orientations.

The framework silicates of zeolites or molecular sieves are commonly characterized in terms of their ring size, wherein the ring size refers to the number of silicon atoms (or alternative atoms, such as those listed above) that are tetrahedrally coordinated with oxygen atoms in a loop to define a pore or channel within the interior of the zeolite. For example, an “8-ring” zeolite refers to a zeolite having pores or channels defined by 8 alternating tetrahedral atoms and 8 oxygen atoms in a loop. The pores or channels defined within a given zeolite may be symmetrical or asymmetrical depending upon various structural constrains that are present in the particular framework silicate.

Zeolites can be classified as having small, medium, large, and extra-large pore structures for pore windows delimited by 8, 10, 12, and more than 12 T-atoms, respectively. Extra-large pore zeolites (>12R) include, for example, AET (14R, e.g. ALPO-8), SFN (14R, e.g. SSZ-59), VFI (18R, e.g. VPI-5), CLO (20R, cloverite), and ITV (30R, ITQ-37) framework type zeolites. Extra-large pore zeolites generally have a free pore diameter of larger than about 0.8 nm. Large pore zeolites (12R) include, for example, LTL, MAZ, FAU, EMT, OFF, *BEA, and MOR framework type zeolites, e.g. mazzite, offretite, zeolite L, zeolite Y, zeolite X, omega, ZSM-2, zeolite T, and Beta. Large pore zeolites generally have a free pore diameter of 0.6 to 0.8 nm. Medium (or intermediate) pore size zeolites (10R) include, for example, MFI, MEL, EUO, MTT, MFS, AEL, AFO, HEU, FER, MWW, and TON framework type zeolites, e.g. ZSM-5, ZSM-11, ZSM-22, MCM-22, silicalite-1, and silicalite-2. Medium pore size zeolites generally have a free pore diameter of 0.45 to 0.6 nm. Small pore size zeolites (8R) include, for example, CHA, RTH, ERI, KFI, LEV, and LTA framework type zeolites, e.g. ZK-4, SAPO-34, SAPO-35, ZK-14, SAPO-42, ZK-21, ZK-22, ZK-5, ZK-20, zeolite A, chabazite, and ALPO-17. Small pore size zeolites generally have a free pore diameter of 0.3 to 0.45 nm.

Synthesis of molecular sieve materials typically involves hydrothermal crystallization from a synthesis mixture comprising sources of all the elements present in the molecular sieve (or zeolite) such as sources of silica but also of alumina etc. In many cases a structure directing agent (SDA) is also present. Structure directing agents are compounds which are believed to promote the formation of molecular sieves and which are thought to act as templates around which certain molecular sieve structures can form and which thereby promote the formation of the desired molecular sieve. Various compounds have been used as structure directing agents including various types of quaternary ammonium cations. Typically, molecular sieve (or zeolite) crystals form around structure directing agents with the structure directing agent occupying pores in the molecular sieve once crystallization is complete. The “as-synthesized” (or “as-made”) molecular sieve will therefore contain the structure directing agent in its pores so that, following crystallization, the “as-synthesized” molecular sieve is usually subjected to a treatment step such as a calcination step to remove the structure directing agent.

For instance, U.S. Pat. No. 6,464,956 B1 and A. Burton et al. (2003) “SSZ-53 and SSZ-59: Two Novel Extra-Large Pore Zeolites,” Chem. Eur. J., v. 9 (23), pp. 5737-5748, disclose the preparation of SSZ-59, an extra-large pore zeolite of SFN framework type, possessing a one-dimensional channel system delimited by 14-membered rings. SSZ-59 synthesis requires the use of complex structure directing agents such as optionally chlorinated N-methyl-N-[(1-phenylcyclopentyl)methyl]heptamethyleneiminium, hexamethyleneiminium, or piperidinium cations.

Although many different molecular sieves have been discovered, there is a continuing need for new molecular sieves (or zeolites) with desirable properties for gas separation and drying, organic conversion reactions, and other applications. New molecular sieves can contain novel internal pore architectures, providing enhanced selectivities in these processes. It is also important to identify new structure directing agents and more efficient methods for the synthesis of molecular sieves to facilitate the preparation of new molecular sieves and/or to reduce the cost of making known molecular sieves.

### SUMMARY

In one aspect, the present disclosure relates to the use of at least one cation selected from 1,2,3,5-tetramethylbenzimidazolium cation of Formula I, 1,2,3,4,5-pentamethylbenzimidazolium cation of Formula II, and/or 1,2,3,4,6-pentamethylbenzimidazolium cation of Formula III:

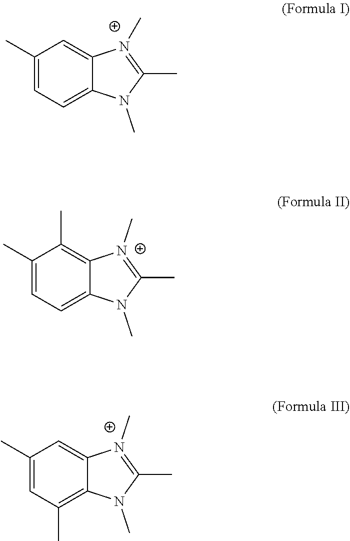

as a structure directing agent (Q) for the preparation of molecular sieves (or zeolites).

In a second aspect, the present disclosure relates to a method of making a molecular sieve (or zeolite), comprising the following steps: (a) preparing a synthesis mixture comprising water, a source of an oxide of tetravalent element (Y), a source of an oxide of trivalent element (X), a structure directing agent (Q) comprising at least one cation selected from the group consisting of 1,2,3,5-tetramethylbenzimidazolium cation of Formula I, 1,2,3,4,5-pentamethylbenzimidazolium cation of Formula II, 1,2,3,4,6-pentamethylbenzimidazolium cation of Formula III, and mixtures thereof, a source of hydroxide ions (OH), and optionally a source of alkali and/or alkaline earth metal element (M); (b) heating said synthesis mixture under crystallization conditions including a temperature of from 100 to 200° C. for a time sufficient to form crystals of said molecular sieve; and (c) recovering at least a portion of the molecular sieve from step (b).

In a third aspect, the present disclosure relates to a molecular sieve (or zeolite) having at least one cation selected from 1,2,3,5-tetramethylbenzimidazolium cations of Formula I, 1,2,3,4,5-pentamethylbenzimidazolium cation of Formula II, and/or 1,2,3,4,6-pentamethylbenzimidazolium cation of Formula III within its pore structure.

These and other features and attributes of the present disclosure and their advantageous applications and/or uses will be apparent from the detailed description which follows. It will of course be appreciated that features described in relation to one aspect of the present invention may be incorporated into other aspects of the present invention. In particular, any two or more of the features described in this specification, including in this summary section, can be combined to form combinations of features not specifically described herein.

### DESCRIPTION OF THE DRAWINGS

FIG. 1 shows the powder XRD pattern of the as-synthesized product of Example 2.

FIG. 2 shows the powder XRD pattern of the calcined product of Example 2.

FIG. 3 shows a SEM image of the as-synthesized product of Example 2.

FIG. 4 shows a SEM image of the as-synthesized product of Example 8.

FIG. 5 shows details of synthesis conditions and resulting products for Examples 2-11.

### DETAILED DESCRIPTION

In a first aspect of the present disclosure, it has been found that cations selected from the group consisting of 1,2,3,5-tetramethylbenzimidazolium cation of Formula I, 1,2,3,4,5-pentamethylbenzimidazolium cation of Formula II, 1,2,3,4,6-pentamethylbenzimidazolium cation of Formula III, and mixtures thereof, can be used as a structure directing agent (Q) for the preparation of molecular sieves.

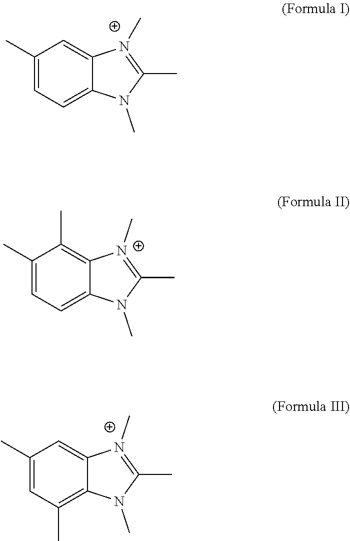

As mentioned above, it is important to identify new structure directing agents and more efficient methods for the synthesis of molecular sieves to facilitate the preparation of new molecular sieves and/or to reduce the cost of making known molecular sieves. It has now been found by the inventors that said cations of Formula I and II can suitably be used for the preparation of molecular sieves, such as aluminosilicate or borosilicate molecular sieves. In particular, it has been found that said cations of Formula I, II and III can suitably be used for the preparation of extra-large pore molecular sieves, such as 14-membered ring molecular sieves, in particular molecular sieves of SFN framework type, e.g. SSZ-59 or EMM-72.

Said 1,2,3,5-tetramethylbenzimidazolium, 1,2,3,4,5-pentamethylbenzimidazolium and 1,2,3,4,6-pentamethylbenzimidazolium cations may be used in a molecular sieve synthesis mixture in any suitable form, such as in their halide form, e.g. chloride, bromide, iodide or fluoride form, in their nitrate form, and/or in their hydroxide form. In case the structure directing agent (Q) is used in its hydroxide form, it also acts as a hydroxide source, providing hydroxide ions (OH) to the synthesis mixture. In case the structure directing agent (Q) is used in a halide form, it also acts as a halide source, providing halide ions (W) to the synthesis mixture. For instance, in case the structure directing agent (Q) is used in its fluoride form, it also acts as a fluoride source, providing fluoride ions (F) to the synthesis mixture.

1,2,3,5-tetramethylbenzimidazolium cation of Formula I. 1,2,3,4,5-pentamethylbenzimidazolium cation of Formula II, and 1,2,3,4,6-pentamethylbenzimidazolium cation of Formula III can be obtained by any suitable method in the art. For instance, the iodide form of the cation may be obtained by reacting iodomethane with 2,5-dimethyl-benzimidazole, 2,4,5-trimethyl-benzimidazole, or 2,4,6-trimethyl-benzimidazole or the bromide form of the cation may be obtained by reacting bromomethane with 2,5-dimethyl-benzimidazole, 2,4,5-trimethyl-benzimidazole, or 2,4,6-trimethyl-benzimidazole. The hydroxide form of the cation may then be obtained by exchanging the iodide or bromide salt with hydroxide, for instance using an ion-exchange resin.

In a second aspect, the present disclosure relates to a method of making a molecular sieve, comprising the following steps:
(a) preparing a synthesis mixture comprising water, a source of an oxide of tetravalent element (Y), a source of an oxide of trivalent element (X), a structure directing agent (Q), a source of hydroxide ions (OH), and optionally a source of alkali and/or alkaline earth metal element (M),
wherein the structure directing agent (Q) comprises at least one cation selected from the group consisting of 1,2,3,5-tetramethylbenzimidazolium cation of Formula I, 1,2,3,4,5-pentamethylbenzimidazolium cation of Formula II, 1,2,3,4,6-pentamethylbenzimidazolium cation of Formula III, and mixtures thereof:

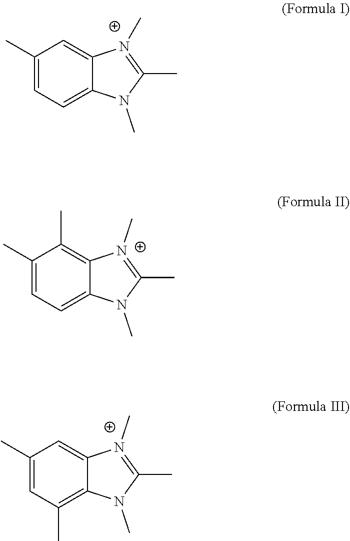

(b) heating said synthesis mixture under crystallization conditions including a temperature of from 100 to 200° C. for a time sufficient to form crystals of said molecular sieve;
(c) recovering at least a portion of the molecular sieve from step (b); and
(d) optionally treating the molecular sieve recovered in step (c) to remove at least part of the structure directing agent (Q).

The structure directing agent (Q) may be present in any suitable form, for example as a halide, such as a fluoride, a chloride, an iodide or a bromide, as a hydroxide or as a nitrate, for instance in its hydroxide form. The structure directing agent (Q) may be present in the synthesis mixture in a Q/Y molar ratio of 0.01 to 1.0, such as 0.05 to 1.0, or 0.05 to 0.8, or 0.1 to 0.7, for instance 0.1 or 0.2 to 0.5, e.g. 0.3 or 0.4.

The synthesis mixture comprises at least one source of an oxide of tetravalent element Y such as Si and/or Ge, preferably Y comprises Si, and more preferably Y is Si. Suitable sources of tetravalent element Y that can be used to prepare the synthesis mixture depend on the element Y that is selected. In embodiments where Y is silicon, Si sources (e.g. silicon oxide sources) suitable for use in the method include silicates, e.g., tetraalkyl orthosilicates such as tetramethylorthosilicate (TMOS) and tetraethylorthosilicate (TEOS), fumed silica such as Aerosil® (available from Evonik), Cabosperse® (available from Cabot) and Cabosil® (available from DMS), precipitated silica such as Ultrasil® and Sipernat® 340 (available from Evonik), alkali metal silicates such as potassium silicate and sodium silicate, and aqueous colloidal suspensions of silica, for example, that sold by E.I. du Pont de Nemours under the tradename Ludox® or that sold by Evonik under the tradename Acrodisp®; preferably silicates, fumed silica, precipitated silica, alkali metal silicates, and in particular colloidal silica. In embodiments where Y is germanium, suitable Ge sources include germanium oxide.

The synthesis mixture comprises at least one source of an oxide of trivalent element X such as Al, B, Fe and/or Ga, preferably X comprises Al and/or B, e.g. Al, and more preferably X is Al and/or B, e.g. Al. Suitable sources of trivalent element X that can be used to prepare the synthesis mixture depend on the element X that is selected. In embodiments where X is aluminum, Al sources (e.g. aluminum oxide sources) suitable for use in the method include aluminum salts, especially water-soluble salts, such as aluminum sulfate, aluminum nitrate, aluminum hydroxide, alkali metal aluminates such as sodium aluminate, and aluminum alkoxides such as aluminum isopropoxide, as well as hydrated aluminum oxides, such as boehmite, gibbsite, and pseudoboehmite, and mixtures thereof. Other aluminum sources include, but are not limited to, other water-soluble aluminum salts, sodium aluminate, aluminum alkoxides, such as aluminum isopropoxide, or aluminum metal, such as aluminum in the form of chips. Especially suitable sources of alumina are water-soluble salts, such as aluminum sulfate, aluminum nitrate, in particular aluminum hydroxide, and alkali metal aluminates such as sodium aluminate and potassium aluminate. In embodiments where X is boron, suitable B sources include boric acid and borate salts such as sodium tetraborate or borax and potassium tetraborate. Sources of boron tend to be more soluble than sources of aluminum in hydroxide-mediated synthesis systems. In embodiments where X is gallium, suitable Ga sources include sodium gallate, potassium gallate, and gallium salts such as gallium chloride, gallium sulfate, and gallium nitrate. In embodiments where X is iron, suitable Fe sources include iron chloride, iron nitrate, and iron oxides.

Alternatively or in addition to previously mentioned sources of Y and X, sources containing both Y and X elements can also be used, such as sources of Si and Al. Examples of suitable sources containing both Si and Al elements include amorphous silica-alumina gels or dried silica alumina powders, silica aluminas, clays, such as kaolin, metakaolin, and zeolites, in particular aluminosilicates such as synthetic faujasite and ultrastable faujasite, for instance Ultrastable Y (USY), beta or other large to medium pore molecular sieves or zeolites.

The synthesis mixture may have a Y/X molar ratio of from 2.5 to 100, such as 5 to 50, for instance 10 to 35, e.g., 10, 15, 20, 25 or 30. In preferred embodiment of this aspect of the invention, Y is Si, X is Al or B, and the molecular sieve is an aluminosilicate or a borosilicate.

The synthesis mixture comprises at least one source of hydroxide ions (OH). For example, hydroxide ions can be present as a counter ion of the structure directing agent (Q) or by the use of aluminum hydroxide or sodium aluminate as a source of Al. Suitable sources of hydroxide ions can also be selected from the group consisting of alkali metal hydroxides, alkaline earth metal hydroxides, ammonium hydroxide, and mixtures thereof; such as from sodium hydroxide, potassium hydroxide, lithium hydroxide, rubidium hydroxide, calcium hydroxide, magnesium hydroxide, ammonium hydroxide, and mixtures thereof; more often sodium hydroxide, potassium hydroxide, lithium hydroxide, ammonium hydroxide, and mixtures thereof; most often sodium hydroxide and/or potassium hydroxide. The synthesis mixture may comprise the hydroxide ions source in a OH/Y molar ratio of from 0.01 to 1.5, such as 0.1 to 1.0, or 0.15 to 0.7, e.g., 0.2 to 0.6.

Optionally, the synthesis mixture may comprise one or more sources of alkali or alkaline earth metal cation (M). If present, M is preferably selected from the group consisting of sodium, potassium, lithium, rubidium, calcium, magnesium and mixtures thereof, preferably sodium and/or potassium, more preferably sodium. The sodium source, when present, may be sodium hydroxide, sodium aluminate, sodium silicate, sodium aluminate or sodium salts such as NaCl, NaBr or sodium nitrate. The potassium source, when present, may be potassium hydroxide, potassium aluminate, potassium silicate, a potassium salt such as KCl or KBr or potassium nitrate. The lithium source, when present, may be lithium hydroxide or lithium salts such as LiCl, LiBr, LiI, lithium nitrate, or lithium sulfate. The rubidium source, when present, may be rubidium hydroxide or rubidium salts such as RbCl, RbBr, RbI, or rubidium nitrate. The calcium source, when present, may be calcium hydroxide, for example. The magnesium source, when present, may be magnesium hydroxide, for example. The alkali or alkaline earth metal cation M may also be present in the one or more sources of a trivalent element X, such as sodium aluminate, sodium tetraborate, potassium tetraborate, sodium gallate, potassium gallate, and/or in the one or more sources of tetravalent element Y, such as potassium silicate and/or sodium silicate. The synthesis mixture may comprise the alkali or alkaline earth metal cation (M) source in a M/Y molar ratio of 0 to 1.0, such as 0 or 0.01 to 0.5, in particular 0 or 0.01 to 0.2 or 0.15, e.g. 0 or 0.01 to 0.1 or even to less than 0.1. Alternatively, the synthesis mixture may be substantially free from alkali or alkaline earth metal cation (M).

The synthesis mixture may optionally comprise at least one source of fluoride ions (F). The source of fluoride ions (F) may be any compound capable of releasing fluoride ions in the molecular sieve synthesis mixture. For instance, fluoride ions can be present as a counter ion of the structure directing agent (Q). Non-limiting examples of sources of fluoride ions (F) include hydrogen fluoride (HF); salts containing one or several fluoride ions, such as metal fluoride, preferably where the metal is an alkali or alkaline earth metal such as sodium, potassium, calcium, magnesium, strontium or barium, or a metal such as aluminum (AlF₃, Al₂F₆) or tin (SnF₂); ammonium fluoride (NH₄F); and ammonium bifluoride (NH₄HF₂). Especially convenient sources of fluoride ions are HF, NH₄F, and NH₄HF₂, in particular HF. Small amounts of fluoride ions (F) may also be present as impurities, for instance in the optional source of alkali or alkaline earth metal cation (M). The fluoride ions (F) may be present in an F/Y molar ratio of 0 to 1.0, for instance 0 or 0.1 to 0.8, such as 0.15 to 0.7, e.g., 0.2 to 0.6. In a preferred embodiment, when the structure directing agent (Q) comprises 1,2,3,4,5-pentamethylbenzimidazolium cation of Formula II, the synthesis mixture contains at least one source of fluoride ions (F). Alternatively, the synthesis mixture may be substantially free from fluoride ions (F).

The synthesis mixture may optionally contain at least one source of halide ions (W), different from fluoride ions, which may be selected from the group consisting of chloride, bromide or iodide. The source of halide ions (W) may be any compound capable of releasing halide ions in the molecular sieve synthesis mixture. For instance, halide ions can be present as a counter ion of the structure directing agent (Q). Non-limiting examples of sources of halide ions include hydrogen chloride, ammonium chloride, hydrogen bromide, ammonium bromide, hydrogen iodide, and ammonium iodide; salts containing one or several halide ions, such as metal halides, preferably where the metal is an alkali or alkaline earth metal such as sodium, potassium, calcium, magnesium, strontium or barium; or tetraalkylammonium halides such as tetramethylammonium halides or tetraethylammonium halides. Small amounts of halide ions (W) may also be present as impurities, for instance in the optional source of alkali or alkaline earth metal cation (M). The halide ions (W) may be present in a W/Y molar ratio of 0 to 0.2, such as 0 to 0.1, for instance less than 0.1 or even 0. Alternatively, the synthesis mixture may be substantially free from halide ions (W).

The synthesis may be performed with or without added nucleating seeds. If nucleating seeds are added to the synthesis mixture, the seeds may be of the same or of a different structure than the molecular sieve obtained by the present method, for instance molecular sieves obtained from a previous synthesis, and may suitably present in an amount from about 0.01 ppm by weight to about 10,000 ppm by weight, based on the synthesis mixture, such as from about 100 ppm by weight to about 5,000 ppm by weight of the synthesis mixture.

The synthesis mixture typically comprises water in a H₂O/Y molar ratio of from 1 to 100, such as 5 to 80 or 5 to 70, for instance 5 or 10 to 50. Depending on the nature of the components in the base mixture, the amount of solvent (e.g., water from the hydroxide solution, and optionally methanol and ethanol from the hydrolysis of silica sources) of the base mixture may be removed such that a desired solvent to Y molar ratio is achieved for the synthesis mixture. Suitable methods for reducing the solvent content may include evaporation under a static or flowing atmosphere such as ambient air, dry nitrogen, dry air, or by spray drying or freeze drying. Water may also be added to the resulting mixture to achieve the desired H₂O/Y molar ratio when too much water is removed during the solvent removal process. In some examples, water removal is not necessary when the preparation have sufficient H₂O/Y molar ratio.

Carbon in the form of CH₂ may be present in the various sources of components used to prepare the synthesis mixture of the present disclosure, e.g., tetravalent element source or trivalent element source, and incorporated into the resulting molecular sieve framework as bridging atoms. Nitrogen atoms may be incorporated into the framework of the molecular sieve material as bridging atoms after the SDA has been removed.

In one or more aspects, the synthesis mixture after solvent adjustment (e.g., where the desired water to silica ratio is achieved) may be mixed by a mechanical process such as stirring or high shear blending to assure suitable homogenization of the base mixture, for example, using dual asymmetric centrifugal mixing (e.g., a FlackTek speedmixer) with a mixing speed of 1,000 to 3,000 rpm (e.g., 2,000 rpm).

The synthesis mixture is then subject to crystallization conditions suitable for the molecular sieve material to form. Crystallization of the molecular sieve material may be carried out under static or stirred conditions in a suitable reactor vessel, such as for example, Teflon® lined or stainless steel autoclaves placed in a convection oven maintained at an appropriate temperature.

The crystallization in step (b) of the method is typically carried out at a temperature of 100° C. to 200° C., such as 120° C. to 180° C., e.g., 160° C. or 170° C., for a time sufficient for crystallization to occur at the temperature used. For instance, at higher temperatures, the crystallization time may be reduced. For instance, the crystallization conditions in step (b) of the method may include heating for a period of from 1 to 100 days, such as from 1 to 50 days, for example from 1 to 30 days, e.g., at least 1 or at least 5 days up to 30 or 20 days. The crystallization time can be established by methods known in the art such as by sampling the synthesis mixture at various times and determining the yield and X-ray crystallinity of precipitated solid. Unless indicated otherwise herein, the temperature measured is the temperature of the surrounding environment of the material being heated, for example the temperature of the atmosphere in which the material is heated.

Typically, the molecular sieve is formed in solution and can be recovered by standard means, such as by centrifugation or filtration. The separated molecular sieve can also be washed, recovered by centrifugation or filtration and dried.

The molecular sieve of the present disclosure, when employed either as an adsorbent or as a catalyst in an organic compound conversion process may be dehydrated (e.g. dried) at least partially. This can be done by heating to a temperature in the range of 80° C. to 500° C., such as 90° C. to 370° C. in an atmosphere such as air, nitrogen, etc., and at atmospheric, subatmospheric or superatmospheric pressures for between 30 minutes and 48 hours. Dehydration may also be performed at room temperature merely by placing the molecular sieve in a vacuum, but a longer time is required to obtain a sufficient amount of dehydration.

As a result of the crystallization process, the recovered product contains within its pores at least a portion of the structure directing agent used in the synthesis. The as-synthesized molecular sieve recovered from step (c) may thus be subjected to thermal treatment or other treatment to remove part or all of the SDA incorporated into its pores during the synthesis. Thermal treatment (e.g., calcination) of the as-synthesized molecular sieve typically exposes the materials to high temperatures sufficient to remove part or all of the SDA, in an atmosphere selected from air, nitrogen, ozone or a mixture thereof in a furnace. While subatmospheric pressure may be employed for the thermal treatment, atmospheric pressure is desired for reasons of convenience. The thermal treatment may be performed at a temperature up to 925° C. e.g., 300° C. to 700° C. or 400 to 600° C. The temperature measured is the temperature of the surrounding environment of the sample. The thermal treatment (e.g., calcination) may be carried out in a box furnace in dry air, which has been exposed to a drying tube containing drying agents that remove water from the air. The heating is usually calcined for at least 1 minute and generally no longer than 1 or at most a few days. The heating may first be carried out under a nitrogen atmosphere and then the atmosphere may be switched to air and/or ozone.

The molecular sieve may also be subjected to an ion-exchange treatment, for example, with aqueous ammonium salts, such as ammonium nitrates, ammonium chlorides, and ammonium acetates, in order to remove remaining alkali metal cations and/or alkaline earth metal cations, if present in the synthesis mixture, and to replace them with protons thereby producing the acid form of the molecular sieve. To the extent desired, the original cations of the as-synthesized material, such as alkali metal cations, can be replaced by ion exchange with other cations. Preferred replacing cations can include hydrogen ions, hydrogen precursor, e.g. ammonium ions and mixtures thereof. The ion exchange step may take place after the as-made molecular sieve is dried. The ion-exchange step may take place either before or after a calcination step.

Optionally, aluminum atoms may be introduced in the molecular sieve framework (wherein part or all of the SDA has been removed) during an exchange process following the hydrothermal synthesis reaction. Framework silicates comprising boron atoms (e.g. borosilicates) may be particularly efficacious for undergoing exchange with aluminum atoms. Such exchange process may comprise exposing the molecular sieve to an aluminum source such as an aqueous solution comprising an aluminum salt, under conditions sufficient to exchange at least a portion and up to substantially all of the boron atoms in the framework silicate with aluminum atoms. For example, a calcined molecular sieve comprising boron may be converted to an aluminosilicate molecular sieve by heating the calcined borosilicate molecular sieve comprising boron with a solution of aluminum sulfate, aluminum nitrate, aluminum chloride and/or aluminum acetate (e.g. in a sealed autoclave in a convention oven at 100° C. or at boiling temperature in an open system). The aluminum treated molecular sieve may then be recovered by filtration and washed with deionized water.

The molecular sieve may also be subjected to other treatments such as steaming and/or washing with solvent. Such treatments are well-known to the skilled person and are carried out in order to modify the properties of the molecular sieve as desired.

The method of the second aspect of the present disclosure may for instance be used to prepare extra-large pore molecular sieves, such as 14-membered ring molecular sieves, e.g., molecular sieves of SFN framework type, e.g. SSZ-59 or EMM-72.

In a third aspect, the present disclosure relates to a molecular sieve having at least one cation selected from 1,2,3,5-tetramethylbenzimidazolium cation of Formula I, 1,2,3,4,5-pentamethylbenzimidazolium cation of Formula II, and/or 1,2,3,4,6-pentamethylbenzimidazolium cation of Formula III:

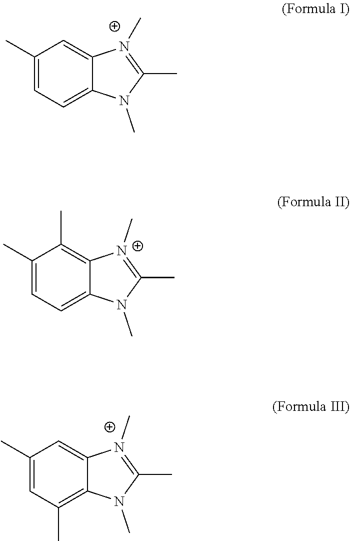

within its pore structure.

Said molecular sieve may be represented by the molecular formula of Formula IV:

(q)Q:(m)X₂O₃:YO₂ (Formula IV),

wherein 0<q≤0.7, 0.005<m≤0.2, X is a trivalent element, Y is a tetravalent element, and Q is 1,2,3,5-tetramethylbenzimidazolium cation of Formula I, 1,2,3,4,5-pentamethylbenzimidazolium cation of Formula II, and/or 1,2,3,4,6-pentamethylbenzimidazolium cation of Formula III. Y may comprise one or more of Si and Ge. For example, Y may comprise or be Si. X may comprise one or more of Al, B, Fe or Ga. For example, X may comprise or be Al and/or B, in particular X may comprise or be Al. In embodiments where Y is Si and X is Al, the molecular sieve is an aluminosilicate. In embodiments where Y is Si and X is B, the molecular sieve is a borosilicate. The oxygen atoms in Formula IV may be replaced by carbon atoms (e.g., in the form of CH₂), which can come from sources of the components used to prepare the as-made molecular sieve. The oxygen atoms in Formula IV can also be replaced by nitrogen atoms, e.g., after the SDA has been removed. Formula IV can represent the framework of a typical molecular sieve having structure directing agent (Q) within its pore structure and is not meant to be the sole representation of such material. The molecular sieve material may contain impurities which are not accounted for in Formula IV. Further, Formula IV does not include the protons and charge compensating ions that may be present in the molecular sieve material.

The variable m represents the molar ratio relationship of X₂O₃ to YO₂ in Formula IV. For example, when m is 0.005, the molar ratio of YO₂ to X₂O₃ is 200 and the Y/X molar ratio is 100 (e.g. the molar ratio of Si/Al or Si/B is 100). m may vary from 0.005 to 0.2, such as from 0.01 to 0.1, e.g. from 0.015 to 0.05. The molar ratio of Y to X may be 2.5 to 100, in particular 5 to 50, such as 5 to 40, for instance 10 to 35.

The variable q represents the molar relationship of Q to YO₂ in Formula IV. For example, when q is 0.1, the Q/Y molar ratio is 0.1. The molar ratio of Q to YO₂ may be from 0 to 0.7, such as from 0.1 to 0.5, e.g. 0.2 to 0.5.

In an especially preferred embodiment, the molecular sieve of the third aspect of the present disclosure may be an extra-large pore molecular sieve, such as a 14-membered ring molecular sieve, e.g., a molecular sieve of SFN framework type, e.g. SSZ-59 or EMM-72.

In a further aspect, the present disclosure relates to a molecular sieve, in particular a molecular sieve of SFN framework type, e.g. SSZ-59 or EMM-72, obtainable by (or obtained by) the method of the second aspect disclosed herein.

Also disclosed herewith is a molecular sieve that may be designated as EMM-72 material having, in its as-synthesized form (e.g., where the SDA has not been removed), an X-ray diffraction pattern including the following peaks in Table 1:

TABLE 1

| Degree 2-theta | Relative Intensity |
|---|---|
| (±0.20) | [100 × I/(Io)] |
| 6.2 | 40-70 |
| 7.3 | 60-100 |
| 8.3 | 40-70 |
| 14.4 | 10-30 |
| 15.8 | 5-15 |
| 17.1 | 10-30 |
| 18.5 | 10-30 |
| 20.7 | 70-100 |
| 22.4 | 30-60 |
| 25.2 | 20-40 |
| 27.5 | 10-30 |
| 35.6 | 10-30 |

Said EMM-72 material, in its as-synthesized form, may have an X-ray diffraction pattern including the following peaks in Table 1A, wherein the d-spacing values have a deviation determined based on the corresponding deviation ±0.20 degree 2-theta when converted to the corresponding values for d-spacing using Bragg's law:

TABLE 1A

| Degree 2- | d-spacing | Relative Intensity |
|---|---|---|
| theta (±0.20) | (Å) | [100 × I/(Io)] |
| 6.2 | 14.22 | 40-70 |
| 7.3 | 12.17 | 60-100 |
| 8.3 | 10.61 | 40-70 |
| 14.4 | 6.15 | 10-30 |
| 15.8 | 5.62 | 5-15 |
| 17.1 | 5.18 | 10-30 |
| 18.5 | 4.79 | 10-30 |
| 20.7 | 4.29 | 70-100 |
| 22.4 | 3.96 | 30-60 |
| 25.2 | 3.53 | 20-40 |
| 27.5 | 3.25 | 10-30 |
| 35.6 | 2.52 | 10-30 |

The XRD patterns with the XRD peaks described herein use Cu(K_{α}) radiation.

Said EMM-72 material, in its as-synthesized form, may be optionally represented by the molecular formula of Formula IV, as defined for the third aspect of the present disclosure.

Also disclosed herewith is a molecular sieve that may be designated as EMM-72 material having, in its calcined form (e.g., where at least part of the SDA has been removed via thermal treatment or other treatment), an X-ray diffraction pattern including the following peaks in Table 2:

TABLE 2

| Degree 2-theta | Relative Intensity |
|---|---|
| (±0.20) | [100 × I/(Io)] |
| 6.2 | 50-80 |
| 7.3 | 50-80 |
| 8.3 | 40-70 |
| 14.5 | 0-10 |
| 15.8 | 0-10 |
| 17.1 | 10-20 |
| 18.5 | 5-15 |
| 20.8 | 70-100 |
| 22.4 | 20-30 |
| 25.3 | 20-30 |
| 27.5 | 10-20 |
| 35.7 | 10-20 |

Said EMM-72 material, in its calcined form, may have an X-ray diffraction pattern including the following peaks in Table 2A, wherein the d-spacing values have a deviation determined based on the corresponding deviation ±0.20 degree 2-theta when converted to the corresponding values for d-spacing using Bragg's law:

TABLE 2A

| Degree 2- | d-spacing | Relative Intensity |
|---|---|---|
| theta (±0.20) | (Å) | [100 × I/(Io)] |
| 6.2 | 14.32 | 50-80 |
| 7.3 | 12.13 | 50-80 |
| 8.3 | 10.58 | 40-70 |
| 14.5 | 6.10 | 0-10 |
| 15.8 | 5.62 | 0-10 |
| 17.1 | 5.17 | 10-20 |
| 18.5 | 4.78 | 5-15 |
| 20.8 | 4.27 | 70-100 |
| 22.4 | 3.96 | 20-30 |
| 25.3 | 3.51 | 20-30 |
| 27.5 | 3.24 | 10-20 |
| 35.7 | 2.51 | 10-20 |

The XRD patterns with the XRD peaks described herein use Cu(K_{α}) radiation.

Said EMM-72, in its calcined form, may have a micropore volume of 0.05 to 0.3, such as 0.1 to 0.25, e.g., 0.17 cc/g; a micropore surface area of 100 to 800 m²/g, such as from 300 to 600 m²/g, e.g., 516 m²/g; and/or an external surface area of 5 to 200 m²/g, such as from 50 to 150 m²/g, e.g., 91 m²/g.

Said EMM-72 material, in its calcined form, may be optionally represented by the molecular formula of Formula V:

(m)X₂O₃:YO₂ (Formula V),

wherein 0.005≤m≤0.2, X is a trivalent element, and Y is a tetravalent element. Y may comprise one or more of Si and Ge. For example, Y may comprise or be Si. X may comprise one or more of Al, B, Fe or Ga. For example, X may comprise or be Al and/or B, in particular X may comprise or be Al. In embodiments where Y is Si and X is Al, the molecular sieve is an aluminosilicate. In embodiments where Y is Si and X is B, the molecular sieve is a borosilicate. The oxygen atoms in Formula V may be replaced by carbon atoms (e.g., in the form of CH₂), which can come from sources of the components used to prepare the as-made molecular sieve. The oxygen atoms in Formula V can also be replaced by nitrogen atoms, e.g., after the SDA has been removed. Formula V can represent the framework of a typical zeolite as defined in the present disclosure, in its calcined form, and is not meant to be the sole representation of said molecular sieve. Said molecular sieve, in its calcined form, may contain SDA and/or impurities after appropriate treatments to remove the SDA and impurities, which are not accounted for in Formula V. Further, Formula V does not include the protons and charge compensating ions that may be present in the calcined molecular sieve.

The variable m represents the molar ratio relationship of X₂O₃ to YO₂ in Formula V. For example, when m is 0.005, the molar ratio of YO₂ to X₂O₃ is 200 and the molar ratio of Y to X is 100 (e.g., the molar ratio of Si/Al or Si/B is 100). m may vary from 0.005 to 0.2, such as from 0.01 to 0.1, e.g. from 0.015 to 0.05. The molar ratio of Y to X may be 2.5 to 100, in particular 5 to 50, such as 5 to 40, for instance 10 to 35.

Said EMM-72 material may suitably be prepared by using the at least one cation defined in the first aspect of the present disclosure, or via the method defined in the second aspect of the present disclosure.

The molecular sieve obtainable by the method of the second aspect of the present disclosure, where part or all of the SDA has been removed, may be used as an adsorbent or as a catalyst or support for catalyst in a wide variety of hydrocarbon conversions, e.g., conversion of organic compounds to a converted product.

The molecular sieve materials of the present disclosure (where part or all of the SDA is removed) may be used as an adsorbent, such as for separating at least one component from a mixture of components in the vapor or liquid phase having differential sorption characteristics with respect to the material. Therefore, at least one component can be partially or substantially totally separated from a mixture of components having differential sorption characteristics with respect to the molecular sieve by contacting the mixture with said molecular sieve to selectively sorb the one component. For instance, in a process for selectively separating one or more desired components of a feedstock from remaining components of the feedstock, the feedstock may be contacted with a sorbent that comprises the molecular sieve of the present disclosure at effective sorption conditions, thereby forming a sorbed product and an effluent product. One or more of the desired components are recovered from either the sorbed product or the effluent product.

The molecular sieve of the present disclosure (where part or all of the SDA is removed) may also be used as a catalyst to catalyze a wide variety of organic compound conversion processes. Examples of chemical conversion processes, which are effectively catalyzed by the molecular sieve described herein, either alone or in combination with one or more other catalytically active substances including other crystalline catalysts, include those requiring a catalyst with acid activity. Examples of organic conversion processes, which may be catalyzed by the molecular sieve described herein include cracking, hydrocracking, isomerization, polymerization, reforming, hydrogenation, dehydrogenation, dewaxing, hydrodewaxing, adsorption, alkylation, transalkylation, dealkylation, hydrodecylization, disproportionation, oligomerization, dehydrocyclization, conversion methanol to olefins, deNOx applications, and combinations thereof. The conversion of hydrocarbon feeds can take place in any convenient mode, for example in fluidized bed, moving bed, or fixed bed reactors depending on the types of process desired.

The molecular sieve of the present disclosure may be formulated into product compositions by combination with other materials, such as binders and/or matrix materials that provide additional hardness to the finished product. These other materials can be inert or catalytically active materials.

For instance, it may be desirable to incorporate the molecular sieve of the present disclosure with another material that is resistant to the temperatures and other conditions employed during use. Such materials include synthetic or naturally occurring zeolites as well as inorganic materials such as clays, silica and/or metal oxides such as alumina and mixtures thereof. The metal oxides may be either naturally occurring or in the form of gelatinous precipitates or gels including mixtures of silica and metal oxides. Use of a resistant material in conjunction with the molecular sieve of the present disclosure, i.e., combined therewith or present during synthesis of the as-made molecular sieve, which crystal is active, tends to change the conversion and/or selectivity of the catalyst in certain organic conversion processes. Inactive resistant materials suitably serve as diluents to control the amount of conversion in a given process so that products can be obtained in an economic and orderly manner without employing other means for controlling the rate of reaction. These materials may be incorporated into naturally occurring clays, e.g., bentonite and kaolin, to improve the crush strength of the product under commercial operating conditions. Said inactive resistant materials, i.e., clays, oxides, etc., function as binders for the catalyst. A catalyst having good crush strength can be beneficial because in commercial use, it is desirable to prevent the catalyst from breaking down into powder-like materials.

Naturally occurring clays which may be used include the montmorillonite and kaolin family, which families include the subbentonites, and the kaolins commonly known as Dixie, McNamee, Georgia and Florida clays or others in which the main mineral constituent is halloysite, kaolinite, dickite, nacrite, or anauxite. Such clays can be used in the raw state as originally mined or after being subjected to calcination, acid treatment or chemical modification. Binders useful for compositing with the molecular sieve of the present disclosure also include inorganic oxides selected from silica, zirconia, titania, magnesia, beryllia, alumina, yttria, gallium oxide, zinc oxide and mixtures thereof.

In addition to the foregoing materials, the molecular sieve of the present disclosure may be composited with a porous matrix material such as silica-alumina, silica-magnesia, silica-zirconia, silica-thoria, silica-beryllia, silica-titania as well as ternary compositions such as silica-alumina-thoria, silica-alumina-zirconia, silica-alumina-magnesia and silica-magnesia-zirconia.

These binder materials are resistant to the temperatures and other conditions, e.g., mechanical attrition, which occur in various hydrocarbon separation processes. Thus the molecular sieve of the present disclosure may be used in the form of an extrudate with a binder. They are typically bound by forming a pill, sphere, or extrudate. The extrudate is usually formed by extruding the molecular sieve, optionally in the presence of a binder, and drying and calcining the resulting extrudate. Further treatments such as steaming, and/or ion exchange may be carried out as required. The molecular sieve may optionally be bound with a binder having a surface area of at least 100 m²/g, for instance at least 200 m²/g, optionally at least 300 m²/g.

The relative proportions of molecular sieve and inorganic oxide matrix may vary widely, with the molecular sieve content ranging from about 1 to about 100 percent by weight and more usually, particularly when the composite is prepared in the form of extrudates, in the range of about 2 to about 95, optionally from about 20 to about 90 weight percent of the composite.

The molecular sieve of the present disclosure may also be used in intimate combination with a hydrogenating component such as tungsten, vanadium, molybdenum, rhenium, nickel, cobalt, chromium, manganese, or a noble metal such as platinum or palladium where a hydrogenation-dehydrogenation function is to be performed. Such hydrogenating components may be incorporated in the composition by way of one or more of the following processes: cocrystallization; exchanged into the composition to the extent a Group IIIA element, e.g., aluminum, is in the structure; or intimately physically admixed therewith. Such components can also be impregnated in or onto the molecular sieve, for example, by treating the molecular sieve with a hydrogenating metal-containing ion. For instance, in the case of platinum, suitable platinum compounds for this purpose include chloroplatinic acid, platinous chloride and various compounds containing a platinum amine complex. Combinations of metals and methods for their introduction can also be used.

It will be understood by a person skilled in the art that the molecular sieve of the present disclosure may contain impurities, such as amorphous materials, unit cells having different topologies (e.g., quartz or molecular sieves of different framework type, that may or may not impact the performance of the resulting catalyst), and/or other impurities (e.g., heavy metals and/or organic hydrocarbons). Typical examples of molecular sieves of different framework type co-existing with the molecular sieve of the present disclosure are e.g., molecular sieves of MTW framework type. The molecular sieve of the present disclosure is preferably substantially free of impurities. The term “substantially free of impurities” (or in the alternative “substantially pure”) used herein means the molecular sieve material contains a minor proportion (less than 50 wt %), preferably less than 20 wt %, more preferably less than 10 wt %, even more preferably less than 5 wt % and most preferably less than 1 wt % (e.g. less than 0.5 wt % or 0.1 wt %), of such impurities (or “non-SFN” framework type), which weight percent (wt %) values are based on the combined weight of impurities and pure molecular sieve. The amount of impurities can be appropriately determined by powder XRD, rotating electron diffraction, and/or SEM/TEM (e.g. different crystal morphologies).

The molecular sieve described herein is substantially crystalline. As used herein, the term “crystalline” refers to a crystalline solid form of a material, including, but not limited to, a single-component or multiple-component crystal form, e.g., including solvates, hydrates, and a co-crystal. Crystalline can mean having a regularly repeating and/or ordered arrangement of molecules, and possessing a distinguishable crystal lattice. For example, the molecular sieve can have different water or solvent content. The different crystalline lattices can be identified by solid state characterization methods such as by XRD (e.g., powder XRD). Other characterization methods known to a person of ordinary skill in the relevant art can further help identify the crystalline form as well as help determine stability and solvent/water content. As used herein, the term “substantially crystalline” means a majority (greater than 50 wt %) of the weight of a sample of a material described is crystalline and the remainder of the sample is a non-crystalline form. In one or more aspects, a substantially crystalline sample has at least 95% crystallinity (e.g., 5% of the non-crystalline form), at least 96% crystallinity (e.g., 4% of the non-crystalline form), at least 97% crystallinity (e.g., 3% of the non-crystalline form), at least 98% crystallinity (e.g., about 2% of the non-crystalline form), at least 99% crystallinity (e.g., 1% of the non-crystalline form), and 100% crystallinity (e.g., 0% of the non-crystalline form).

Aspects of the disclosure are described in greater detail by way of specific examples. The following examples are offered for illustrative purposes, and are not intended to limit the disclosure in any manner. Those of skill in the relevant art will readily recognize a variety of parameters can be changed or modified to yield essentially the same results.

### EXAMPLES

The present invention is further illustrated below without limiting the scope thereto.

In these examples, the X-ray diffraction (XRD) patterns of the as-synthesized and as-calcined materials were recorded on an X-Ray Powder Diffractometer (Bruker DaVinci D8 Discovery instrument) in continuous mode using a Cu Kα radiation, Bragg-Bentano geometry with Vantec 500 detector, in the 2θ range of 2 to 50 degrees. The interplanar spacings, d-spacings, were calculated in Angstrom units, and the relative intensities of the lines, I/Iₒ is the ratio of the peak intensity to that of the intensity of the strongest line, above background. The intensities are uncorrected for Lorentz and polarization effects. The location of the diffraction peaks in 2-theta, and the relative peak area intensities of the lines, I/I(o), where Io is the intensity of the strongest line, above background, were determined with the MDI Jade peak search algorithm. It should be understood that diffraction data listed as single lines may consist of multiple overlapping lines which under certain conditions, such as differences in crystallographic changes, may appear as resolved or partially resolved lines. Typically, crystallographic changes can include minor changes in unit cell parameters and/or a change in crystal symmetry, without a change in the framework connectivity. These minor effects, including changes in relative intensities, can also occur as a result of differences in cation content, framework composition, nature and degree of pore filling, crystal size and shape, preferred orientation and thermal and/or hydrothermal history.

The scanning electron microscopy (SEM) images of the as-synthesized materials were obtained on a Hitachi 4800 Scanning Electron Microscope. SEM images were used to aid assessment of product purity. The presence of obviously different crystal morphologies in a SEM image can be an indication of impurities in the form of other crystalline materials. Such an approximate analysis can be especially useful in identifying the presence of formation of relatively minor amounts of crystalline impurities which may not be identifiable on product XRD patterns.

The following measurements were conducted on samples that were ion-exchanged and calcined. For each sample subjected to ion-exchange and calcination, the procedure used was as follows: the as-prepared sample was washed two times with a IM ammonium nitrate solution and then calcined at 500° C. for 16 hours.

The overall BET surface area (S_{BET}) of the materials was determined by the BET method as described by S. Brunauer, et al. (1938) “Adsorption of Gases in Multimolecular Layers,” J. Am. Chem. Soc., v. 60, pp. 309-319, incorporated herein by reference, using nitrogen adsorption-desorption at liquid nitrogen temperature. The external surface area (Sₑₓₜ) of the material was obtained from the t-plot method, and the micropore surface area (S_{micro}) of the material was calculated by subtracting the external surface area (Sₑₓₜ) from the overall BET surface area (S_{BET}).

The micropore volume (V_{micro}) of the materials can be determined using methods known in the relevant art. For example, the micropore volume of the materials can be measured with nitrogen physisorption, and the data can be analyzed by the t-plot method described in Lippens, B. C. et al. (1965) “Studies on pore system in catalysts: V. The t method”, J. Catal., v. 4, pg. 319, which describes micropore volume method and is incorporated herein by reference. The molar ratios and conditions used for the syntheses of Examples 2-11, as well as

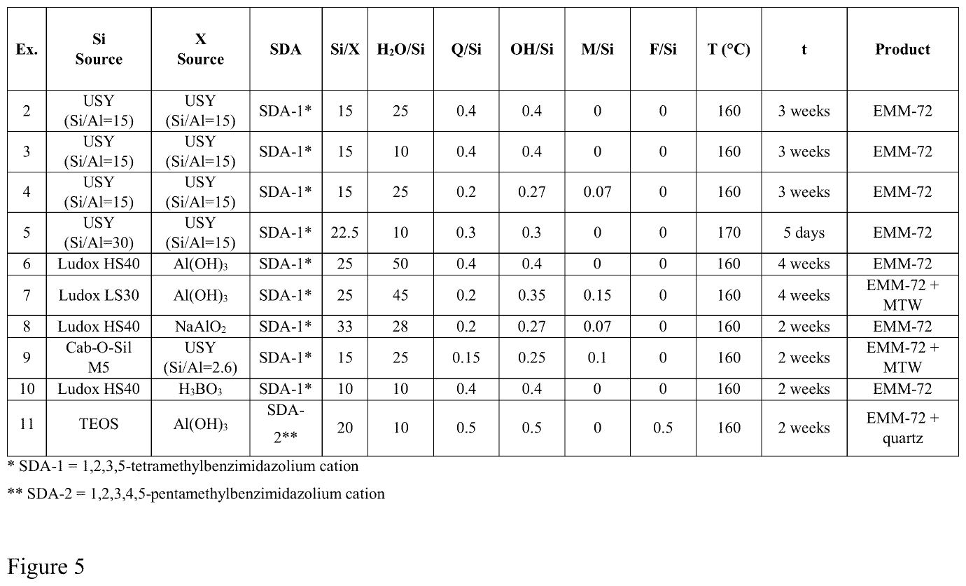

the resulting products, are detailed below and summarized in FIG. 5.

### Example 1a: Synthesis of 1,2,3,5-tetramethylbenzimidazolium Hydroxide (SDA-1)

30 g of 2,5-dimethyl-benzimidazole, 116 g of iodomethane and 42 g of potassium carbonate were added into 300 mL acetonitrile (CH₃CN) in a 500 mL round-bottom flask equipped with a magnetic stir bar. The suspension was subsequently refluxed for 18 hours, then cooled to room temperature. The solution was then filtered through a Buchner funnel, and the filtrate solution was concentrated by a rotovap. Dichloromethane was added to the concentrated solution to remove the leftover potassium salts. The filtrate in dichloromethane was concentrated by a rotovap and dried under vacuum to obtain 1,2,3,5-tetramethyl-1H-benzimidazolium iodide.

The iodide salt of 1,2,3,5-tetramethylbenzimidazolium was then ion-exchanged with ion-exchange resin Amberlite® IRN78 OH hydroxide form, with a iodide:resin:water weight ratio of 1:3.5:5, to its hydroxide form. The exchange was performed at room temperature overnight.

### Example 1b: Synthesis of 1,2,3,4,5-pentamethylbenzimidazolium Hydroxide (SDA-2)

30 g of 3,4-dimethylbenzene-1,2-diamine, 31.8 g of trimethylorthoformate, and 1.07 g of sulfamic acid in 275 mL of methanol were stirred at room temperature. The reaction was monitored by thin-layer chromatography and was complete in 3 hours as evidenced by the disappearance of the starting 3,4-dimethylbenzene-1,2-diamine and the formation of a single lower spot. The solvent was removed via rotovap and the reaction contents partitioned between ethyl acetate (300 mL) and water (300 mL). The organic layer was dried over magnesium sulfate, filtered, and rotovapped to yield 24.3 g (69%) of 2,4,5-trimethyl-benzimidazole.

To an overhead stirred solution of 24.3 g of 2,4,5-trimethyl-benzimidazole and 31.4 g of potassium carbonate in 230 mL of acetonitrile (CH₃CN) was added 53.8 g of iodomethane. The reaction was heated at 80° C. After 4 hours, thin-layer chromatography still showed the presence of starting 2,4,5-trimethyl-benzimidazole, so an additional 40 g of iodomethane was added and heating continued. Disappearance of the starting material via thin-layer chromatography after 2 additional hours of heating and the emergence of a blue baseline spot (10% methanol/dichloromethane) indicated the formation of product. The acetonitrile was removed via rotovap and the resulting solids triturated with ethyl acetate and filtered to give ca. 16.3 g of 1,2,3,4,5-pentamethylbenzimidazolium iodide.

The iodide salt of 1,2,3,4,5-pentamethylbenzimidazolium was then ion-exchanged with ion-exchange resin Amberlite® IRN78 OH hydroxide form, with a iodide:resin:water weight ratio of 1:3.5:5, to its hydroxide form. The exchange was performed at room temperature overnight.

### Example 2: SDA-1, USY Zeolite, Si/Al=15

In a PTFE liner for a 23 mL Steel Parr autoclave, the following were mixed together: 8.79 g of SDA-1 solution (9 wt %) and 0.72 g of Ultrastable Y (USY) zeolite with a Si/Al molar ratio of 15 (available from Zeolyst as CBV720), and the mixture was stirred at 50° C. until 3.4 g water were lost, to produce a synthesis mixture having the following composition in terms of molar ratios:

25H₂O:1SiO₂:0.033Al₂O₃:0.4QOH.

The liner was then capped, sealed within a 23 mL Parr autoclave, and placed within a spit inside of a convection oven. The reactor was heated at 160° C. for 3 weeks under tumbling conditions (about 30 rpm). The product was isolated by filtration, rinsed with deionized water and dried. The as-synthesized material was then calcined to 580° C. in air within a box furnace with a ramping rate of 3° C./minute. The temperature remained at 580° C. for 8 hours and then the box furnace was allowed to cool.

XRD analysis of the as-synthesized and calcined products showed the material to have similar powder XRD patterns to respectively as-synthesized and calcined SSZ-59 zeolite in terms of degree 2-theta and d-spacing but with different relative intensities (as illustrated in Tables I/IA and II/IIA of U.S. Pat. No. 6,464,956 B1, which is incorporated herein by reference in its entirety). This new product was identified as EMM-72.

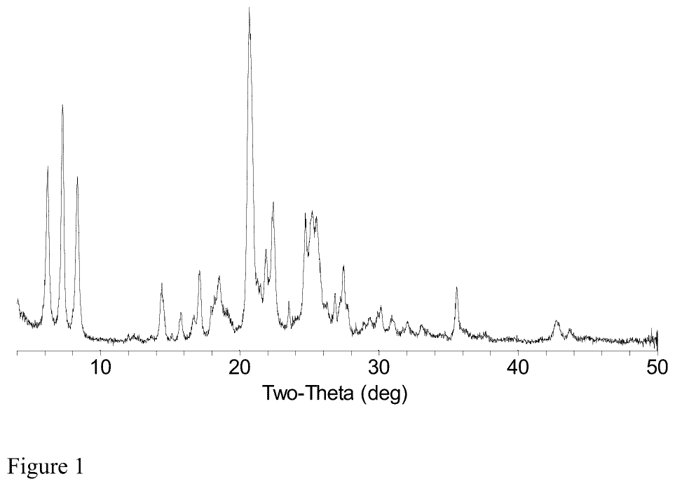

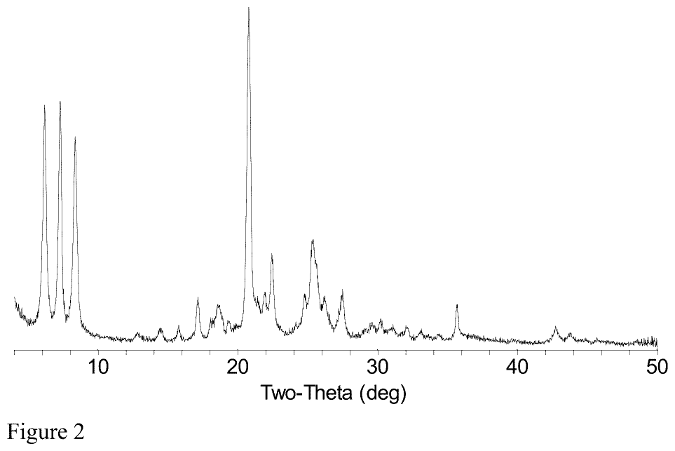

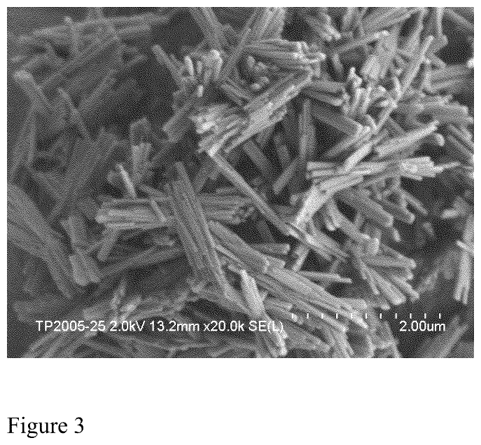

FIGS. 1 and 2 show the powder XRD patterns of respectively the as-synthesized and calcined products of Example 2. Tables 3 and 4 below show the lists of peaks and intensities for the as-synthesized and calcined EMM-72 products of Example 2. FIG. 3 shows a SEM image of the as-synthesized product of Example 2.

The micropore surface area (S_{micro}) of the calcined EMM-72 product of Example 2 was 516 m²/g, its external surface area (Sₑₓₜ) was 91 m²/g, and its micropore volume (V_{micro}) was 0.17 cc/g.

TABLE 3

| Degree 2- | d-spacing | Relative Intensity |
|---|---|---|
| theta (±0.20) | (Å) | [100 × I/(Io)] |
| 6.2 | 14.22 | 51.2 |
| 7.3 | 12.17 | 71.4 |
| 8.3 | 10.61 | 50.1 |
| 14.4 | 6.15 | 18.4 |
| 15.8 | 5.62 | 8.6 |
| 17.1 | 5.18 | 21.1 |
| 18.5 | 4.79 | 18.0 |
| 20.7 | 4.29 | 100.0 |
| 22.4 | 3.96 | 36.1 |
| 25.2 | 3.53 | 33.1 |
| 27.5 | 3.25 | 20.3 |
| 35.6 | 2.52 | 16.4 |

TABLE 4

| Degree 2- | d-spacing | Relative Intensity |
|---|---|---|
| theta (±0.20) | (Å) | [100 × I/(Io)] |
| 6.2 | 14.32 | 68.4 |
| 7.3 | 12.13 | 69.0 |
| 8.3 | 10.58 | 57.8 |
| 14.5 | 6.10 | 3.8 |
| 15.8 | 5.62 | 4.8 |
| 17.1 | 5.17 | 13.3 |
| 18.5 | 4.78 | 9.3 |
| 20.8 | 4.27 | 100.0 |
| 22.4 | 3.96 | 21.6 |
| 25.3 | 3.51 | 24.9 |
| 27.5 | 3.24 | 14.0 |
| 35.7 | 2.51 | 10.8 |

### Example 3: SDA-1, USY Zeolite, Si/Al=15

This Example was conducted in the same conditions as Example 2, except that the synthesis mixture contained water in a H₂O/Si molar ratio of 10.

After 3 weeks of heating at 160° C., pure EMM-72 product was obtained, as identified by its XRD pattern.

### Example 4: SDA-1, USY Zeolite, Si/Al=15, NaOH

This Example was conducted in the same conditions as Example 2, except that the synthesis mixture contained a smaller amount of SDA-1 and some sodium hydroxide (NaOH, 4 wt %), to produce a synthesis mixture having the following composition in terms of molar ratios:

25H₂O:1SiO₂:0.033Al₂O₃:0.2QOH:0.07NaOH.

After 3 weeks of heating at 160° C., pure EMM-72 product was obtained, as identified by its XRD pattern.

### Example 5: SDA-1, USY Zeolite, Si/Al=22.5

This Example was conducted in a similar manner as Example 2, but starting from a mixture of Ultrastable Y (USY) zeolites with respective Si/Al molar ratios of 15 and 30 (available from Zeolyst as respectively CBV720 and CBV760), resulting in a global Si/Al molar ratio of 22.5, with a synthesis mixture having the following composition in terms of molar ratios:

10H₂O:1SiO₂:0.022Al₂O₃:0.3QOH.

After 5 days of heating at 170° C., pure EMM-72 product was obtained, as identified by its XRD pattern.

### Example 6: SDA-1, Colloidal Silica, Aluminum Hydroxide, Si/Al=25

This Example was conducted in a similar manner as Example 2, except that Ludox HS40 (40 wt % colloidal silica suspension) was used as the Si source and aluminum hydroxide (Al(OH)₃, 54 wt %) was used as the Al source, with a synthesis mixture having the following composition in terms of molar ratios:

50H₂O:1SiO₂:0.02Al₂O₃:0.4QOH.

After 4 weeks of heating at 160° C., pure EMM-72 product was obtained, as identified by its XRD pattern.

### Example 7: SDA-1, Colloidal Silica, Aluminum Hydroxide, Si/Al=25, NaOH

This Example was conducted in the same conditions as Example 6, except that Ludox LS30 (30 wt % colloidal silica suspension) was used as the Si source and that the synthesis mixture contained a smaller amount of water and SDA-1 and some sodium hydroxide (NaOH, 4 wt %), to produce a synthesis mixture having the following composition in terms of molar ratios:

45H₂O:1SiO₂:0.02Al₂O₃:0.2QOH:0.15NaOH.

After 4 weeks of heating at 160° C., EMM-72 product with a minor amount of MTW phase was obtained, as identified by its XRD pattern.

### Example 8: SDA-1, Colloidal Silica, Sodium Aluminate, Si/Al=33, NaOH

This Example was conducted in a similar manner as Example 2, except that Ludox HS40 (40 wt % colloidal silica suspension) was used as the Si source and sodium aluminate (NaAlO₂, 25 wt % Al₂O₃, 19.3 wt % Na₂O) was used as the Al source, with a synthesis mixture having the following composition in terms of molar ratios:

28H₂O:1SiO₂:0.015Al₂O₃:0.2QOH:0.07NaOH.

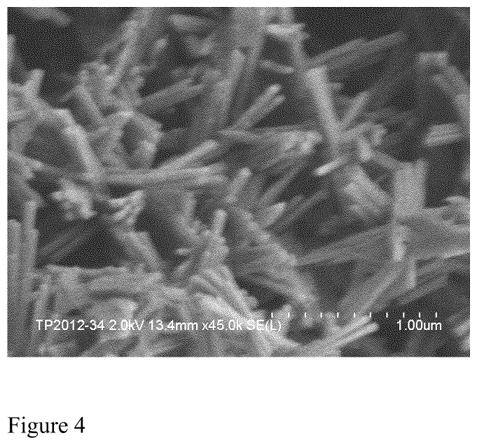

After 2 weeks of heating at 160° C., pure EMM-72 product was obtained, as identified by its XRD pattern. FIG. 4 shows a SEM image of the as-synthesized product of Example 8.

### Example 9: SDA-1, Fumed Silica, USY Zeolite, Si/Al=15

This Example was conducted in a similar manner as Example 2, except that fumed silica (available from Cabot as Cab-O-Sil® M5) and Ultrastable Y (USY) zeolite with a Si/Al molar ratio of 2.6 (available from Zeolyst as CBV500) were used as the Si and Al sources, in the presence of sodium hydroxide (NaOH, 4 wt %), with a synthesis mixture having the following composition in terms of molar ratios:

25H₂O:1SiO₂:0.033Al₂O₃:0.15QOH:0.1NaOH.

After 2 weeks of heating at 160° C., EMM-72 product with a minor amount of MTW phase was obtained, as identified by its XRD pattern.

### Example 10: SDA-1, Colloidal Silica, Boric Acid, Si/B=10

This Example was conducted in a similar manner as Example 2, except that Ludox HS40 (40 wt % colloidal silica suspension) was used as the Si source and boric acid (H₃BO₃, 3.9 wt %) was used as a B source, with a synthesis mixture having the following composition in terms of molar ratios:

10H₂O:1SiO₂:0.05B₂O₃:0.4QOH.

After 2 weeks of heating at 160° C., pure EMM-72 product was obtained, as identified by its XRD pattern.

### Example 11: SDA-2, TEOS, Aluminum Hydroxide, Si/Al=20, HF

1.24 g of tetraethylorthosilicate (TEOS, >99 wt %) and 0.028 g AI (OH) 3 (Sigma, 54 wt %) were hydrolyzed in 15.7 g of SDA-2 (3.9 wt % solution) to remove the ethanol and water (15 g in total). Then 0.12 g of HF (48 wt % solution) was added to the mixture to produce a synthesis mixture having the following composition in terms of molar ratios:

10H₂O:1SiO₂:0.025Al₂O₃:0.5QOH:0.5HF.

The synthesis mixture was homogenized by hand in a Teflon container, and transferred to a 23 mL Teflon-lined stainless steel autoclave (Parr). After 2 weeks of heating at 160° C. (convection oven, rotation about 40 rpm), EMM-72 product with a minor amount or quartz was obtained, as identified by its XRD pattern.

While the present invention has been described and illustrated with reference to particular embodiments, it will be appreciated by those of ordinary skill in the art that the invention lends itself to many different alterations, modifications, and variations not specifically illustrated herein. It will also be apparent to those skilled in the art that when numerical lower limits and numerical upper limits are listed herein, ranges from any lower limit to any upper limit are contemplated. Also, all numerical values within the detailed description herein are modified by “about” the indicated value, and take into account experimental error and variations that would be expected by a person having ordinary skill in the art.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

Additionally or alternately, the invention relates to:

Embodiment 1: Use of at least one cation selected from 1,2,3,5-tetramethylbenzimidazolium cation of Formula I, 1,2,3,4,5-pentamethylbenzimidazolium cation of Formula II, and 1,2,3,4,6-pentamethylbenzimidazolium cation of Formula III:

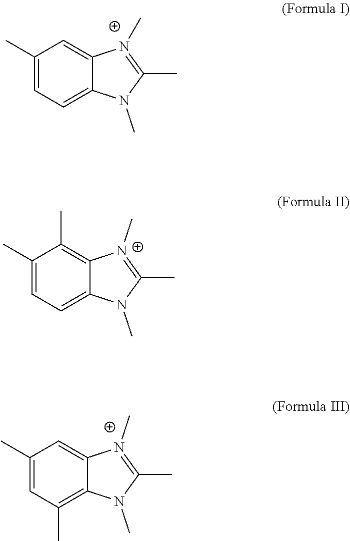

as a structure directing agent (Q) for the preparation of a molecular sieve.

Embodiment 2: The use of embodiment 1, wherein the structure directing agent (Q) is in the form of a halide, hydroxide or nitrate, preferably wherein the structure directing agent (Q) is its hydroxide form.

Embodiment 3: The use of embodiment 1 or 2, wherein the molecular sieve is an aluminosilicate molecular sieve or a borosilicate molecular sieve, in particular an aluminosilicate molecular sieve.

Embodiment 4: The use of any one of embodiments 1 to 3, wherein the molecular sieve is an extra-large pore molecular sieve, preferably a 14-membered ring molecular sieve, more preferably wherein the molecular sieve has a SFN framework type, most preferably wherein the molecular sieve is EMM-72.

Embodiment 5: A method of making a molecular sieve, comprising:
(a) preparing a synthesis mixture comprising water, a source of an oxide of tetravalent element (Y), a source of an oxide of trivalent element (X), a structure directing agent (Q), a source of hydroxide ions (OH), and optionally a source of alkali and/or alkaline earth metal element (M),
wherein the structure directing agent (Q) comprises at least one cation selected from the group consisting of 1,2,3,5-tetramethylbenzimidazolium cation of Formula I, 1,2,3,4,5-pentamethylbenzimidazolium cation of Formula II, 1,2,3,4,6-pentamethylbenzimidazolium cation of Formula III, and mixtures thereof:

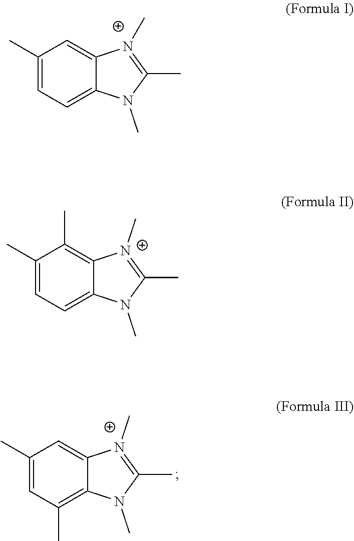

(b) heating said synthesis mixture under crystallization conditions including a temperature of from 100 to 200° C. for a time sufficient to form crystals of said molecular sieve; and
(c) recovering at least a portion of the molecular sieve from step (b).

Embodiment 6: The method of embodiment 5, wherein the structure directing agent (Q) is in the form of a halide, hydroxide or nitrate, preferably wherein the structure directing agent (Q) is its hydroxide form.

Embodiment 7: The method of embodiment 5 or 6, wherein the tetravalent element (Y) is selected from the group consisting of silicon, germanium, and mixtures thereof, preferably wherein the tetravalent element (Y) comprises silicon, more preferably wherein the tetravalent element (Y) is silicon.

Embodiment 8: The method of any one of embodiments 5 to 7, wherein the trivalent element (X) is selected from the group consisting of aluminum, boron, iron, gallium, and mixtures thereof, preferably wherein the trivalent element (X) comprises aluminum and/or boron, more preferably wherein the trivalent element (X) is aluminum and/or boron, in particular aluminum.

Embodiment 9: The method of any one of embodiments 5 to 8, wherein the synthesis mixture has the following composition in terms of molar ratios:

| Molar | Typical | Preferred | More preferred |
|---|---|---|---|
| ratios | range | range | range |
| Y/X | 2.5-100 | 5-50 | 10-35 |
| Q/Y | 0.01-1.0 | 0.05-0.8 | 0.1-0.7 |
| OH/Y | 0.01-1.5 | 0.1-1.0 | 0.15-0.7 |
| M/Y | 0-1.0 | 0.01-0.5 (if M | 0.01-0.2 (if M |
| | | present) | present) |
| H₂O/Y | 1-100 | 5-80 | 5-50 |

Embodiment 10: The method of any one of embodiments 5 to 9, further comprising treating the molecular sieve recovered in step (c) to remove at least part of the structure directing agent (Q).

Embodiment 11: The method of any one of embodiments 5 to 10, wherein the molecular sieve is a borosilicate and wherein the process further comprises exchanging at least a portion of the boron atoms in the framework silicate with aluminum atoms.

Embodiment 12: A molecular sieve having at least one cation selected from 1,2,3,5-tetramethylbenzimidazolium cation of Formula I, 1,2,3,4,5-pentamethylbenzimidazolium cation of Formula II, and 1,2,3,4,6-pentamethylbenzimidazolium cation of Formula III:

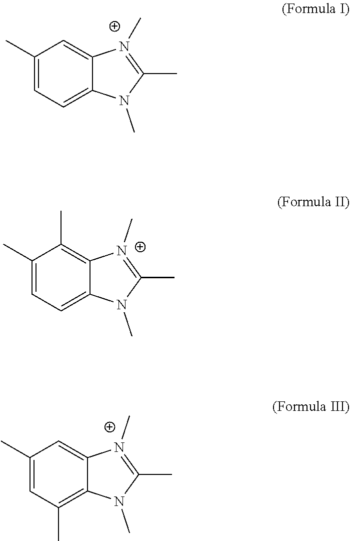

within its pore structure.

Embodiment 13: The molecular sieve of embodiment 12, obtainable by the method of any one of claims 5 to 11.

Embodiment 14: The molecular sieve of embodiment 12 or 13, wherein the molecular sieve is an aluminosilicate or a borosilicate molecular sieve, in particular an aluminosilicate.

Embodiment 15: The molecular sieve of any one of embodiments 12 to 14 wherein the molecular sieve is an extra-large pore molecular sieve, preferably a 14-membered ring molecular sieve, more preferably wherein the molecular sieve has a SFN framework type, most preferably wherein the molecular sieve is EMM-72.

1. A method of making a molecular sieve, comprising:
(a) preparing a synthesis mixture comprising water, a source of an oxide of tetravalent element (Y), a source of an oxide of trivalent element (X), a structure directing agent (Q), a source of hydroxide ions (OH), and optionally a source of alkali and/or alkaline earth metal element (M),
wherein the structure directing agent (Q) comprises at least one cation selected from the group consisting of 1,2,3,5-tetramethylbenzimidazolium cation of Formula I, 1,2,3,4,5-pentamethylbenzimidazolium cation of Formula II, 1,2,3,4,6-pentamethylbenzimidazolium cation of Formula III, and mixtures thereof: 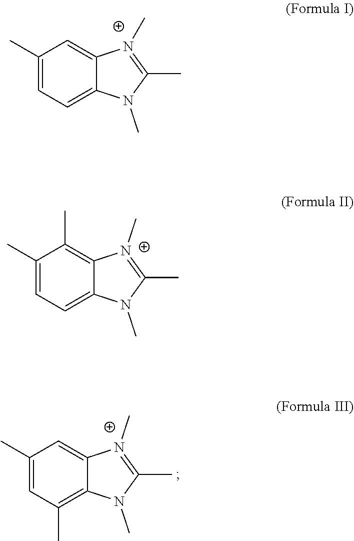
(b) heating said synthesis mixture under crystallization conditions including a temperature of from 100 to 200° C. for a time sufficient to form crystals of said molecular sieve; and
(c) recovering at least a portion of the molecular sieve from step (b).

2. The method of claim 1, wherein the structure directing agent (Q) is in the form of a halide, hydroxide or nitrate.

3. The method of claim 1, wherein the tetravalent element (Y) is selected from the group consisting of silicon, germanium, and mixtures thereof.

4. The method of claim 1, wherein the tetravalent element (Y) comprises silicon.

5. The method of claim 1, wherein the trivalent element (X) is selected from the group consisting of aluminum, boron, iron, gallium, and mixtures thereof.

6. The method of claim 1, wherein the trivalent element (X) comprises aluminum and/or boron.

7. The method of claim 1, wherein the synthesis mixture has a molar ratio of Y/X of 2.5 to 100, a molar ratio of Q/Y of 0.01 to 1.0, a molar ratio of OH/Y of 0.01 to 1.5, a molar ratio of M/Y of 0/1.0, and a molar ratio of H₂O/Y of 1-100.

8. The method of claim 1, wherein the synthesis mixture has a molar ratio of Y/X of 5 to 50, a molar ratio of Q/Y of 0.05 to 0.8, a molar ratio of OH/Y of 0.1 to 1.0, a molar ratio of H₂O/Y of 5 to 80, and optionally a molar ratio of M/Y of 0.01 to 0.5.

9. The method of claim 1, wherein the synthesis mixture has a molar ratio of Y/X of 10 to 35, a molar ratio of Q/Y of 0.1 to 0.7, a molar ratio of OH/Y of 0.15 to 0.7, a molar ratio of H₂O/Y of 5 to 50, and optionally a molar ratio of M/Y of 0.01 to 0.2.

10. The method of claim 1, further comprising treating the molecular sieve recovered in step (c) to remove at least part of the structure directing agent (Q).

11. The method of claim 1, wherein the molecular sieve is a borosilicate and wherein the process further comprises exchanging at least a portion of the boron atoms in the framework silicate with aluminum atoms.

12. The method of claim 1, wherein the molecular sieve is an aluminosilicate molecular sieve or a borosilicate molecular sieve.

13. The method of claim 1, wherein the molecular sieve is a 14-membered ring molecular sieve.

14. The method of claim 1, wherein the molecular sieve has a SFN framework type.

15. The method of claim 1, wherein the molecular sieve is EMM-72.

16. A molecular sieve made according to the method of claim 1 having at least one cation selected from 1,2,3,5-tetramethylbenzimidazolium cation of Formula I, 1,2,3,4,5-pentamethylbenzimidazolium cation of Formula II, and 1,2,3,4,6-pentamethylbenzimidazolium cation of Formula III: 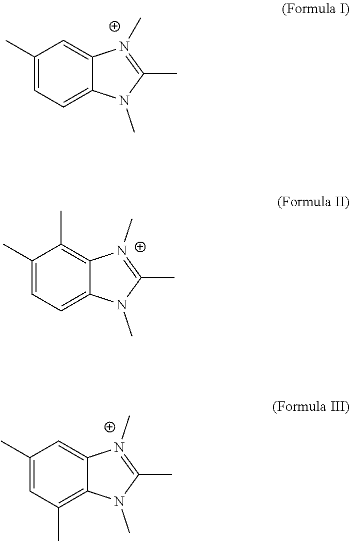
within its pore structure.

17. The molecular sieve of claim 16, wherein the molecular sieve is an aluminosilicate or a borosilicate molecular sieve.

18. The molecular sieve of claim 16 wherein the molecular sieve is a 14-membered ring molecular sieve.

19. The molecular sieve of claim 16, wherein the molecular sieve has a SFN framework type.

20. The molecular sieve of claim 16, wherein the molecular sieve is EMM-72.
